(19) United States
(12) Patent Application Publication
(10) Pub. No.: US 2025/0282682 A1
(43) Pub. Date: Sep. 11, 2025

(54) PLASTICIZER FOR GEOPOLYMERS AND METHOD FOR PLASTICIZING GEOPOLYMERS

(71) Applicant: Lubrizol Advanced Materials, Inc., Cleveland, OH (US)

(72) Inventors: Nathan J. Bartlett, Matlock, Derbyshire (GB); Maryam Derkani, Bebington, Wirral (GB); Brant Walkley, Sheffield (GB)

(73) Assignee: Lubrizol Advanced Materials, Inc., Cleveland, OH (US)

(21) Appl. No.: 18/860,039

(22) PCT Filed: Apr. 24, 2023
(86) PCT No.: PCT/US2023/019603

§ 371 Date: Oct. 25, 2024

Related U.S. Application Data
(60) Provisional application No. 63/335,241, filed on Apr. 27, 2022.

(51) Int. Cl. C04B 28/00; C04B 14/06; C04B 28/26; C04B 40/00

(52) U.S. Cl. CPC C04B 28/003; C04B 14/06; C04B 28/26; C04B 40/0028

(57) ABSTRACT

Water-soluble polymers containing repeat units of methacrylic acid may be used as plasticizers for geopolymer composition. Geopolymer compositions made from an aluminosilicate and an alkali activator plasticized by a polymer containing repeat units derived from methacrylic acid or salts thereof, methacrylate, or mixtures thereof.

### BACKGROUND OF THE INVENTION

Low calcium alkali activated materials, sometimes referred to as “geopolymers,” are a class of cementitious materials that are used in a wide variety of applications. Geopolymers can be used to completely or partially replace traditionally used, Portland cement compositions as a cementitious binding ingredient in construction product formulations, such as mortars. The applications in which low calcium alkali activated materials can be used to replace Portland cements include in concretes, infrastructure (roads, runways, bridges and paving), cementitious repair materials, cementitious coatings (e.g. coating systems, floor screeds, passive fire protection coatings), grouts, and bonding mortars. Low calcium alkali activated materials may also be used in other applications such as those where articles are formed in controlled manufacturing conditions, such as bricks, blocks, tiles, sewerage pipes, waste immobilization, and load bearing reinforced articles (e.g. lintels). With the increasing use of 3D printing in construction, there is also interest in using low calcium alkali activated materials in 3D printed buildings.

For final geopolymers to maintain high strength and durability, it is important to maintain a low water content in the reactive composition while maintaining good flow and workability of the material. Plasticizing additives can be used to enhance flow and workability in the formulation, while maintaining desirable properties in the final composition.

Therefore, it is desirable to provide a geopolymer composition which has improved processability for a long period without significant retardation of hardening or reduction of the strength of the final geopolymer composition.

### SUMMARY OF THE INVENTION

The present invention provides a composition comprising (1) a reactive geopolymer mixture comprising (A) a reactive solid comprising an aluminosilicate and a calcium source, (B) an alkali activator, (C) a solvent comprising or consisting of water, and (2) a plasticizer additive comprising a water-soluble polymer which is a homopolymer or copolymer containing repeat units derived from methacrylic acid or salts thereof, methacrylate, or mixtures thereof. In one embodiment, the reactive geopolymer mixture comprises (A) a reactive solid comprising of an aluminosilicate and a calcium source, (B) an alkali activator derived from colloidal silica, (C) a solvent comprising or consisting of water, and the plasticizer additive is a water-soluble homopolymer or copolymer containing repeat units derived from methacrylic acid or salts thereof partially or fully neutralized with sodium, potassium or mixtures thereof. In one embodiment, the aluminosilicate comprises or consists of metakaolin. In another embodiment, the aluminosilicate is selected from the group consisting of metakaolin, calcined clay, fly ash, incineration ash (including but not limited to rice husk, sugarcane leaves ash, palm oil, boiler ash, wastepaper sludge ash, municipal solid waste ash, bottom ash), natural pozzolans, volcanic ash, ground granulated blast furnace slag (from steel or iron), other industrial ground slag (including but not limited to phosphorous, ferronickel, ferrochrome magnesia-iron, copper, nickel, titaniferous), mine tailings or wastes (including but not limited to coal gangue, red mud), zeolite, feldspars, framework aluminosilicates, synthetic glassy precursors (silicates, aluminates, aluminosilicates) and mixtures thereof. The calcium source may be any source of calcium oxide, such as blast furnace slag or hydrated lime.

The present invention also provides a method of plasticizing an aluminosilicate geopolymer precursor by combining a reactive aluminosilicate with an alkali activator and a plasticizing additive, wherein the plasticizing additive comprises a water-soluble polymer which is a homopolymer or copolymer containing repeat units derived from methacrylic acid or salts thereof, methacrylate, or mixtures thereof. In one embodiment, the method of plasticizing includes combining (1) a geopolymer precursor mixture comprising (A) a reactive solid comprising an aluminosilicate, such as metakaolin, and a calcium source, such as blast furnace slag, (B) an alkali activator derived from colloidal silica, (C) a solvent comprising or consisting of water, with (2) a water-soluble homopolymer or copolymer containing repeat units derived from methacrylic acid or salts thereof partially or fully neutralized with sodium, potassium or mixtures thereof.

In one embodiment of the invention, the reactive geopolymer mixture (meaning the reactive sold, alkali activator, and any solvent contained or added therein, but excluding the water-soluble polymer component and any water contained therein) has an H₂O/MₓO ratio of less than 14, less than 12.5, less than 12, less than 10, or even less than 7. In the calculation of the ratio, x is 2 for Lithium, Sodium, and Potassium, and x is 1 for Calcium. The H₂O/MₓO ratio is calculated using the following formula

Total Moles of Free or Potentially Released Water in the Geopolymer Composition/(((Total Moles of Li, Na, and/or K)/2)+Total Moles of Ca).

The various embodiments will be described in more detail below in the following detailed description of the invention.

### DETAILED DESCRIPTION OF THE INVENTION

Various preferred features and embodiments will be described below by way of non-limiting illustration.

The amount of each chemical component described is presented exclusive of any solvent, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

It is known that some of the materials described above may interact in the final formulation, so that the components of the final formulation may be different from those that are initially added. For instance, the alkali activator reacts with the aluminosilicate to form a geopolymer. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

### Reactive Solid

The reactive solid component of the present invention contains an aluminosilicate material. The aluminosilicate useful in the present invention may be derived from calcined clay, incineration ash, including but not limited to fly ash, rice husk ash, sugarcane leaves ash, palm oil ash, boiler ash, wastepaper sludge ash, municipal solid waste ash, bottom ash, natural pozzolans, volcanic ash, ground granulated blast furnace slag (from steel or iron), industrial ground slag, including but not limited to phosphorous, ferronickel, ferrochrome magnesia-iron, copper, nickel, titaniferous, mine tailings or wastes (including but not limited to coal gangue, red mud) zeolite, feldspars, and mixtures thereof. In one embodiment, the aluminosilicate comprises or consists of metakaolin. In another embodiment, the aluminosilicate comprises at least 10% or even at least 50% by weight metakaolin.

In one embodiment, the reactive solid also includes a source of calcium. The calcium source may comprise or consist of calcium oxide. In another embodiment, the calcium source may be from waste materials that have calcium oxide present. Such an embodiment includes a calcium source that comprises or consists of ground granulated blast furnace slag. In another embodiment, the calcium source may comprise or consist of hydrated lime.

### Alkali Activator

The composition of the present invention also employs an alkali activator. In one embodiment, the alkali activator comprises an alkali silicate. Useful alkali silicates are represented by the formula M₂ₙSiO₂₊ₙ but may also be described as (M₂O)ₙSiO₂ or (M₂O)ₙSiO₂·xH₂O or M₂ₙSiO₂₊ₙ·xH₂O. In these formulas, M represents an alkali metal, for example, sodium, lithium, or potassium, or mixtures thereof. In the formulas above, n may be from 0.33 to 1.33, for example, 0.43 to 0.73. In some embodiments, the alkali metal silicate will have a molar (or weight (wt.)) ratio of SiO₂/M₂O (where M=Li, Na, K or mixtures thereof) of 3.0 to 0.75, or even 2.33 to 1.36.

Alkali silicate useful in the present invention may be selected from a variety of sodium, lithium, and/or potassium silicates or mixtures thereof. In one embodiment, the alkali silicate comprises or consists of sodium metasilicate. Examples of commercially available alkali silicates are available from various suppliers including PQ Corporation (US), Groupo IQE (Spain), ICL (UK), and Ankit (India). Alkali silicates useful for this invention are available commercially and are understood to have varying compositions by those skilled in the art. Many of these have non-integer stoichiometry. Their behavior is complex but is documented in the literature (e.g. Weldes and Lange. “Properties of Soluble Silicates,” Industrial and Engineering Chemistry, Vol. 61, No. 4, April 1969).

In another embodiment, the alkali activator is derived from colloidal silica. In such an embodiment, the alkali silicate comprises the reaction product of colloidal silica with an alkali metal oxide, an alkali metal hydroxide, an alkali metal carbonate, an alkali metal bicarbonate, other alkali silicate or mixtures thereof. Colloidal silica is a suspension of fine amorphous, nonporous, and typically spherical silica particles in a liquid phase. Commercially available colloidal silicas contain about 10% to about 60% by weight SiO₂. In some embodiments, the SiO₂ particles are around 1 to 100 nm in size. In some embodiments, the colloidal silicas are negatively charged solutions stabilized by the addition of for example, Na₂O, NaOH, NH₄OH, at low treat rates such as from 0.025% to 1.5% of the total weight of the colloidal silica formulation. In other embodiments, the colloidal silicas are positively charged solutions stabilized by surface coatings of Al₂O₃, or mixtures of Al₂O₃ and Cl, at treat rates of 0.025% to 2.5% of the total weight of the colloidal silica formulation. Examples of commercially available colloidal silicas include those sold under the following trademarks: LUDOX® (E.I. duPont de Nemours & Co., Wilmington, Delaware), NALCOAG® (Nalco Chemical Co., Chicago, Illinois), NYACOL® (Nyacol, Inc., Ashland, Massachusetts), SNOWTEX® (Nissan Chemical Industries, Ltd., Tokyo, Japan), and SYTON® (Monsanto Ltd., London, England and St. Louis, Missouri). Alkali metal oxides, hydroxides, carbonates, bicarbonates, are well known in the art and include those based on sodium, lithium, or potassium.

Geopolymers are formed in the present invention by the reaction of the aluminosilicate and calcium oxide in the reactive solid mixture and the alkali silicate in the alkali activator, in the presence of solvent. In one embodiment of the invention, the reactive geopolymer mixture (defined as the reactive solid, alkali activator, and any solvent contained or added therein, but excluding the water-soluble polymer component and any water contained therein) has an H₂O/MₓO ratio of less than 14, less than 12.5, less than 12, less than 10, or even less than 7. In the calculation of the ratio, x is 2 for Lithium, Sodium, and Potassium, and x is 1 for Calcium. The H₂O/MₓO ratio is calculated using the following formula: Total Moles of Free or Potentially Released Water in the Geopolymer Composition/(((Total Moles of Li, Na, and/or K)/2)+Total Moles of Ca).

### Solvent

The composition of the present invention also comprises one or more solvents. In one embodiment, the solvent comprises or consists of water. In another embodiment, the solvent comprises water and one or more co-solvents miscible with water. Such co-solvents may include, for example, alcohols such as C1-6 aliphatic alcohols such as ethanol, isopropanol, diacetone alcohol, glycols such as C2-6 alkylene glycols, alcohol ethers such as methoxy-, ethoxy-, propoxy- and butoxyethanol, methoxy-, ethoxy-, propoxy- and butoxypropanol, glycol ethers such as diethylene glycol and dipropylene glycol, glycol esters such as 2-ethoxyethyl acetate, 2-ethoxypropyl acetate, or polyglycols such as polyethyleneglycol, where the polyethylene glycol has a molecular weight of less than 600, tetrahydrofuran (THF), methyl THF, or 1,3-dioxolane or mixtures thereof.

It should be understood that in some embodiments, the solvent component for the pre-sent invention may be separately added to the other solid components of the invention. In other embodiments, the solvent may be included in one or more of the other components used in the invention, such as in the alkali activator component or as part of the plasticizing additive.

### Plasticizer Additive

The plasticizer additive of the present invention is a water-soluble polymer which is a homopolymer or copolymer containing repeat units derived from methacrylic acid or salts thereof, methacrylate, or mixtures thereof.

The water-soluble polymers useful in the present invention may be selected from those now known or hereafter developed. In one embodiment, the water-soluble polymer is a homopolymer or copolymer containing repeat units derived from methacrylic acid or salts thereof, methacrylate, or mixtures thereof. In another embodiment, the water-soluble polymer is a copolymer that comprises repeat units derived from methacrylate, methacrylic acid, salts of methacrylic acid, mixtures of methacrylate, methacrylic acid, and salts of methacrylic acid, and optionally, other monomers such acrylate, acrylic acid, alkyl (meth)acrylate, acrylate esters (e.g. ethyl, n-butyl etc.), vinyl chloride, vinylidene chloride, vinyl acetate, vinyl trimethoxysilane, styrene, styrene sulfonic acid, acrylamide, diacetone acrylamide, maleic acid, fumaric acid, and dienes such as butadiene or combinations thereof. In another embodiment, the water-soluble polymer comprises at least 50%, or at least 75%, at least 90%, or even at least 95% repeat units derived from methacrylic acid. In another embodiment, the water-soluble polymer consists of repeat units derived from methacrylic acid. In another embodiment, the water-soluble polymer is a salt of a polymer consisting of repeat units derived from methacrylic acid wholly or partially neutralized by, lithium, sodium, or potassium or mixtures thereof.

The water-soluble polymer useful in the present invention may have a weight average molecular weight measured by aqueous gas permeation chromatography (GPC) (Mw) greater than 1,000 up to 40,000. In one embodiment, the water-soluble polymer has a Mw from 1,000 to 35,000, or even, 2,000, or 3,000 up to 30,000. In another embodiment, the water-soluble polymer has a Mw of less than 30,000, for example 2,000 or 3,000 to 25,000 or 20,000 or even 3,000 to 10,000. In some embodiments, the water-soluble polymer useful in the present invention may have a Mw of 1,000, 2,000, 3,000, 4,000, 5,000, 6,000, 7,000, 8,000, 9,000 or 10,000.

The water-soluble polymers used in the present invention are usually provided as a solution of particles of polymers in a liquid substance. Typically, the liquid substance is water.

In some embodiments of the present invention, the plasticizing additive may be combined with the alkali activator in a manner provide a metastable colloidal solution that does not crystalize and thus, making a shelf-stable activating liquid component. Such an activating liquid component may also include one or more solvents including water.

In some embodiments, the composition of the present invention may include one or more additional additives. These additional additives may be included as part of any individual component, as part of the reactive liquid composition, as part of a mixture with the reactive solid, or even added after the reactive solid, alkali activator, and plasticizer components are combined to form the composition. Examples of these additional additives are described below.

In some embodiments, the composition may further contain one or more additional polymers. The polymers may be included as solids or in the form of a solution or dispersion. These additional polymers can perform a variety of functions in the composition. However, the additional polymers are not a required component for the essential features of the disclosure.

The compositions of the present invention can further include one or more additives, including pigments, fillers, dispersants, coalescents, pH modifying agents, latex polymers, plasticizers, defoamers, surfactants, rheology modifiers or thickeners, humectants, flame retardants, surfactants, preservatives, biocides, corrosion inhibitors, co-solvents, and combinations thereof. The choice of additives in the composition will be influenced by a number of factors, including but not limited to the intended use of the composition.

Examples of suitable pigments include metal oxides, such as titanium dioxide, zinc oxide, iron oxide, or combinations thereof. In certain embodiments, the composition includes a titanium dioxide pigment. Examples of commercially available titanium dioxide pigments are KRONOS® 2101, KRONOS® 2310, available from Kronos WorldWide, Inc. (Cranbury, NJ), TI-PURE® R-900, available from DuPont (Wilmington, DE), or TIONA® ATI commercially available from Millenium Inorganic Chemicals. Titanium dioxide is also available in concentrated dispersion form. An example of a titanium dioxide dispersion is KRONOS® 4311, also available from Kronos WorldWide, Inc.

Examples of suitable fillers include sand, calcium carbonate, nepheline syenite (25% nepheline, 55% sodium feldspar, and 20% potassium feldspar), feldspar (an aluminosilicate), diatomaceous earth, calcined diatomaceous earth, talc (hydrated magnesium silicate), silica (silicon dioxide), alumina (aluminum oxide), clay (hydrated aluminum silicate), kaolin (kaolinite, hydrated aluminum silicate), mica (hydrous aluminum potassium silicate), pyrophyllite (aluminum silicate hydroxide), perlite, baryte (barium sulfate), Wollastonite (calcium metasilicate), and combinations thereof. In certain embodiments, the composition comprises a calcium carbonate filler. In some embodiments, the fillers will be included in the reactive solid mixture portion of the composition. If included, the fillers may be present in amounts of up to 50% by weight of the reactive solid mixture. In cases where fillers are included, the amount of the aluminosilicate in the reactive solid mixture will be reduced to accommodate for the presence of the fillers. Other fillers may include reinforcing fibers, such as glass fibers, natural fibers, plastic fibers, steel fibers, carbon fibers, carbon nanotubes and the like now known or hereafter developed. In one embodiment of the invention, sand is used as a filler component. In another embodiment, the filler component is a standardized sand sieved by the method specified in ASTM C77820-30.

Suitable coalescents, which aid in film formation during drying, include ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, 2,2,4-trimethyl-1,3-pentanediol monoisobutyrate, and combinations thereof.

Examples of suitable rheology modifiers or thickening agents include hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, and combinations thereof. HEUR polymers are linear reaction products of diisocyanates with polyethylene oxide end-capped with hydrophobic hydrocarbon groups. HASE polymers are homopolymers of (meth)acrylic acid, or copolymers of (meth)acrylic acid, (meth)acrylate esters, or maleic acid modified with hydrophobic vinyl monomers. HMHECs include hydroxyethyl cellulose modified with hydrophobic alkyl chains. Hydrophobically modified polyacrylamides include copolymers of acrylamide with acrylamide modified with hydrophobic alkyl chains (N-alkyl acrylamide). In certain embodiments, the composition includes a hydrophobically modified hydroxyethyl cellulose thickener.

Defoamers serve to minimize frothing during mixing and/or application of the composition. Suitable defoamers include silicone oil defoamers, such as polysiloxanes, polydimethylsiloxanes, polyether modified polysiloxanes, and combinations thereof. Exemplary silicone-based defoamers include BYK®-035, available from BYK USA Inc. (Wallingford, CT), the TEGO® series of defoamers, available from Evonik Industries (Hopewell, VA), and the DREWPLUS® series of defoamers, available from Ashland Inc. (Covington, KY). Other suitable defoamers include non-silicone defoamers or silicone free defoamers, such as oil based, or oil emulsions. Exemplary non-silicone defoamers include Efka™ 2526, Efka™ 2788 available from BASF SE, BYK™ 011 available from BYK USA Inc. (Wallingford, CT).

Suitable biocides can be incorporated to inhibit the growth of bacteria and other microbes in the composition during storage. Exemplary biocides include 2-[(hydroxymethyl)amino]ethanol, 2-[(hydroxymethyl) amino] 2-methyl-1-propanol, o-phenylphenol, sodium salt, 1,2-benzisothiazolin-3-one, 2-methyl-4-isothiazolin-3-one (MIT), 5-chloro2-methyland-4-isothiazolin-3-one (CIT), 2-octyl-4-isothiazolin-3-one (OTT), 4,5-dichloro-2-n-octyl-3-isothiazolone, as well as acceptable salts and combinations thereof. Suitable biocides also include mildewcides that inhibit the growth mildew or its spores in the composition. Examples of mildewcides include 2-(thiocyanomethylthio) benzothiazole, 3-iodo-2-propynyl butyl carbamate, 2,4,5,6-tetrachloroisophthalonitrile, 2-(4-thiazolyl)benzimidazole, 2-N-octyl4-isothiazolin-3-one, diiodomethyl p-tolyl sulfone, as well as acceptable salts and combinations thereof. In certain embodiments, the composition contains 1,2-benzisothiazolin-3-one or a salt thereof. Biocides of this type include PROXEL® BD20, commercially available from Arch Chemicals, Inc (Atlanta, GA).

When combined with the alkali activator and the solvent the reactive solid component reacts with the alkali activator in a geopolymerization reaction to provide cementitious material. The water-soluble polymer component acts as a plasticizer to reduce the amount of water required in the composition while increasing the workability of the composition and the strength of the final material. When the two components of the composition system described herein are combined, they form a composition comprising a geopolymer component formed from the reaction product of the alkali activator and the aluminosilicate contained in the reactive solid component.

The compositions of the present invention can be suitable for use as mortars, concretes, grouts, mineral foams or coatings.

In one embodiment, the reactive solid may be mixed with the alkali activator and the solvent with the water-soluble polymer plasticizer component added promptly to the mixture. In one embodiment, a reactive solid mixture containing an aluminosilicate and a calcium source, such as metakaolin and blast furnace slag or hydrated lime is prepared while a separate alkali activator solution is prepared using water as a solvent; in this embodiment, the reactive solid mixture can be mixed with the alkali activator and the plasticizing additive may be added to the combined reactive components as a top treat. In another embodiment, the composition of the present invention is prepared by combining the alkali activator and water-soluble polymer component together to form an activating liquid component and then combining the activating liquid component with the reactive solid component. In another embodiment, a reactive solid mixture containing an aluminosilicate and a calcium source, such as metakaolin and blast furnace slag or hydrated lime, may be mixed together with solid alkali silicate; solvent and the plasticizer may be added to this solid mixture separately or sequentially to initiate the reaction of the reactive solid with the alkali silicate. The mixing of the components may be accomplished by any method now known or hereafter developed. For example, mixing tools common in the production of mortars or concretes may be used. The mixed composition may be converted into the desired shape during the time in which it has good formability.

Shaped bodies made from the compositions of the present invention include components of buildings or similar structures, for example shells, walls, floors, or used as a coating or a filling.

The present invention further comprises an article made from the composition described herein. In particular, the present invention provides an article made from a geopolymer, wherein the geopolymer composition is made from (A) a reactive solid comprising an aluminosilicate and a calcium source, (B) an alkali activator, (C) a solvent comprising or consisting of water, in the presence of a plasticizer component. Each of the individual components are as described in detail herein.

In addition, the present invention also provides a method of plasticizing an aluminosilicate geopolymer precursor by combining the reactive solid, with the alkali activator, solvent, and a plasticizing additive. Each of the individual components are described herein in detail.

### EXAMPLES

The following examples provide illustrations of the invention. These examples are non-exhaustive and are not intended to limit the scope of the invention.

An Alkali Activator solution was prepared according to the formulation set forth in Table 1 for use in the formulations in Table 2.

TABLE 1

| | | | Potassium | |
|---|---|---|---|---|
| | | Colloidal | silicate | |
| | | Silica | anhydrous | |
| 50% | KOH | (50% SiO2 | (SiO2:K2O | |
| NaOH (aq) | (solid) | (aqueous)) | 2.5:1 wt %) | water |
| (wt %) | (wt %) | (wt %) | (wt %) | (wt %) |
| 20.1 | 3.3 | 16.3 | 31.6 | 28.8 |

Reactive geopolymer mixtures were prepared according to the formulation set forth in Table 2.

TABLE 2

| | Formulation | Metakaolin | GGBFS¹ | Alkali Activator | Sand filler² | Hydrated |
|---|---|---|---|---|---|---|
| Ex. | type | (wt %) | (wt %) | solution (wt %) | (wt %) | lime (wt %) |
| 1a | Paste | 44.2 | 0.0 | 54.0 | 0.0 | 1.8 |
| 1b | Paste repeat 1 | 44.2 | 0.0 | 54.0 | 0.0 | 1.8 |
| 1c | Paste repeat 2 | 44.2 | 0.0 | 54.0 | 0.0 | 1.8 |
| 1d | Paste repeat 3 | 44.5 | 0.0 | 53.8 | 0.0 | 1.8 |
| 1e | Paste repeat 4 | 44.2 | 0.0 | 54.0 | 0.0 | 1.8 |
| 1f | Mortar repeat 5 | 22.4 | 0.0 | 27.4 | 49.3 | 0.9 |
| 2a | Paste | 41.5 | 10.4 | 48.2 | 0.0 | 0.0 |
| 2b | Paste repeat 1 | 41.5 | 10.4 | 48.2 | 0.0 | 0.0 |
| 2c | Mortar repeat 2 | 19.4 | 4.8 | 22.5 | 53.3 | 0.0 |
| 3 | Paste | 44.2 | 0.0 | 54.0 | 0.0 | 1.8 |
| 4a | Paste | 44.2 | 0.0 | 54.0 | 0.0 | 1.8 |
| 4b | Paste repeat 1 | 44.2 | 0.0 | 54.0 | 0.0 | 1.8 |
| 4c | Mortar repeat 2 | 22.4 | 0.0 | 27.4 | 49.3 | 0.9 |
| 5 | Paste | 44.2 | 0.0 | 54.0 | 0.0 | 1.8 |
| 6 | Paste | 44.2 | 0.0 | 54.0 | 0.0 | 1.8 |
| 7 | Paste | 44.2 | 0.0 | 54.0 | 0.0 | 1.8 |
| 8 | Paste | 44.2 | 0.0 | 54.0 | 0.0 | 1.8 |
| 9a | Paste | 44.2 | 0.0 | 54.0 | 0.0 | 1.8 |
| 9b | Paste repeat 1 | 44.2 | 0.0 | 54.0 | 0.0 | 1.8 |
| 9c | Mortar repeat 2 | 22.4 | 0.0 | 27.4 | 49.3 | 0.9 |
| 10 | Paste | 44.2 | 0.0 | 54.0 | 0.0 | 1.8 |
| 11a | Paste | 44.2 | 0.0 | 54.0 | 0.0 | 1.8 |
| 11b | Paste repeat 1 | 44.2 | 0.0 | 54.0 | 0.0 | 1.8 |
| 11c | Mortar repeat 2 | 22.4 | 0.0 | 27.4 | 49.3 | 0.9 |
| 12 | Paste | 44.2 | 0.0 | 54.0 | 0.0 | 1.8 |
| 13a | Paste | 41.5 | 10.4 | 48.2 | 0.0 | 0.0 |
| 13b | Paste repeat 1 | 41.5 | 10.4 | 48.2 | 0.0 | 0.0 |
| 13c | Mortar repeat 2 | 19.4 | 4.8 | 22.5 | 53.3 | 0.0 |
| 14 | Paste | 44.2 | 0.0 | 54.0 | 0.0 | 1.8 |
| 15 | Paste | 44.2 | 0.0 | 54.0 | 0.0 | 1.8 |
| 16 | Paste | 44.2 | 0.0 | 54.0 | 0.0 | 1.8 |

¹Ground Granulated Blast Furnace Slag
²Standardized sand (sieved per ASTM C77820-30)

The geopolymer compositions formed from the formulations in table 2 have the metal molar rations as set forth in Table 3.

TABLE 3

| | | | | | | H₂O/M₂O mol | H₂O/MₓO mol |
|---|---|---|---|---|---|---|---|
| Examples | Na: | K: | Ca: | Si: | Al | (M = Na, K only) | (M = Na, K (x = 2 and Ca (x = 1)) |
| 1, 3, 4, 5, 6, 7, | 0.37 | 0.37 | 0.06 | 1.81 | 1.00 | 11.0 | 9.5 |
| 8, 9, 10, 11, 12, | | | | | | | |
| 14, 15, 16 | | | | | | | |
| 2, 13 | 0.33 | 0.33 | 0.19 | 1.81 | 1.00 | 11.0 | 6.9 |

The formulations prepared in Table 3 were top treated with a Plasticizer Polymer Additive as set forth in Table 4.

TABLE 4

| | | | Top treat of |
|---|---|---|---|
| | | Plasticizer Polymer | Plasticizer Polymer |
| | | Additive Actives | Additive Actives |
| Ex. | Plasticizer Polymer Additive | (% solids) | (wt %) |
| 1a | — | — | 0 |
| 1b | — | — | 0 |
| 1c | — | — | 0 |
| 1d | — | — | 0 |
| 1e | — | — | 0 |
| 1f | — | — | 0 |
| 2a | — | — | 0 |
| 2b | — | — | 0 |
| 2c | — | — | 0 |
| 3 | Ultrazine ™ NA¹ | 88 | 1.1 |
| 4a | Morwet ™ D809² | 96.2 | 1.1 |
| 4b | Morwet ™ D809 | 96.2 | 1.1 |
| 4c | Morwet ™ D809 | 96.2 | 0.6 |
| 5 | Melflux ™ 2651 F³ | 100 | 1.1 |
| 6 | Melflux ™ 4930 F⁴ | 100 | 1.1 |
| 7 | Polyacrylic acid | 50 | 1.1 |
| | (7300 Mw) | | |
| 8 | Polyacrylic acid | 63 | 1.1 |
| | (2000 Mw) | | |
| 9a | Sodium 2-acrylamido-2-methylpropane sulfonate | 50 | 1.1 |
| | (15,000 Mw) | | |
| 9b | Sodium 2-acrylamido-2-methylpropane sulfonate | 50 | 1.1 |
| | (15,000 Mw) | | |
| 9c | Sodium 2-acrylamido-2-methylpropane sulfonate | 50 | 0.6 |
| | (15,000 Mw) | | |
| 10 | Sodium 2-acrylamido-2-methylpropane sulfonate | 37 | 1.1 |
| | (30,000 Mw) | | |
| 11a | Sodium neutralised methacrylic acid | 40 | 1.1 |
| | (5000 Mw) | | |
| 11b | Sodium neutralised methacrylic acid | 40 | 1.1 |
| | (5000 Mw) | | |
| 11c | Sodium neutralised methacrylic acid | 40 | 0.6 |
| | (5000 Mw) | | |
| 12 | Sodium neutralised methacrylic acid | 30 | 1.1 |
| | (30,000 Mw) | | |
| 13a | Sodium neutralised methacrylic acid | 40 | 1.3 |
| | (5000 Mw) | | |
| 13b | Sodium neutralised methacrylic acid | 40 | 1.3 |
| | (5000 Mw) | | |
| 13c | Sodium neutralised methacrylic acid | 40 | 0.6 |
| | (5000 Mw) | | |
| 14 | Sodium neutralised methacrylic acid | 89 | 1.1 |
| | (6000 Mw) | | |
| 15 | Sodium neutralised methacrylic acid | 89 | 1.1 |
| | (2000 Mw) | | |
| 16 | Sodium neutralised methacrylic acid | 45 | 1.1 |
| | (7300 Mw) | | |

¹Ultrazine ™ NA is a sodium lignosulfonate polymer commercially available from Borregaard AS.
²Morwet ™ 809 is an alkylnaphthalene sulfonate polymer commercially available from Nouryon.
³MELFLUX ™ 2651 F is a polycarboxylic ether polymer commercially available from BASF.
⁴MELFLUX ™ 4930 F is a polycarboxylic ether polymer commercially available from BASF.

The compositions of Table 4 were evaluated for performance attributes as reported in Table 5, where the compositions of Table 4 were used as the Portland cement in the test methods listed.

TABLE 5

| | Compressive strength | | | | | | | |
|---|---|---|---|---|---|---|---|---|
| | (ASTM C109) | | Slump (ASTM C1437) | | | | Vicat Set | |
| | 28 Day | 28 Day Max | (workability) | | | | (ASTM C191-19) | |
| | Compressive | Compressive | Initial | 20 min | 40 min | 60 min | Initial | Final |
| | strength | strength | slump | slump | slump | slump | set | set |
| Ex. | (MPa) | (MPa) | (mm) | (mm) | (mm) | (mm) | (min) | (min) |
| 1a | | | 88 | | | 10 | | |
| 1b | | | 98 | 86 | 59 | 41 | | |
| 1c | | | 103 | 76 | 71 | 52 | | |
| 1d | | | | | | | 165 | 375 |
| 1e | | | 97 | 66 | 46 | 37 | | |
| 1f | 73 ± 7 | 80 | | | | | | |
| 2a | | | 58 | 45 | 37 | 36 | | |
| 2b | | | | | | | 225 | 300 |
| 2c | 106 ± 10 | 118 | | | | | | |
| 3 | | | 59 | | | 14 | | |
| 4a | | | 66 | | | 20 | | |
| 4b | | | 91 | 82 | 61 | 50 | | |
| 4c | 73.1 ± 1.0 | 74 | | | | | | |
| 5 | | | 21 | | | 7 | | |
| 6 | | | 25 | | | 12 | | |
| 7 | | | 38 | | | 0 | | |
| 8 | | | 35 | | | 5 | | |
| 9a | | | 66 | | | 20@ 50 min | | |
| 9b | | | 79 | 52 | 43 | 33 | | |
| 9c | 70 ± 22 | 85 | | | | | | |
| 10 | | | 95 | 77 | 55 | 42 | | |
| 11a | | | 121 | 136 | 94 | 75 | | |
| 11b | | | | | | | 180 | 360 |
| 11c | 76 ± 6 | 80 | | | | | | |
| 12 | | | 103 | 98 | 81 | 60 | | |
| 13a | | | 107 | 116 | 106 | 99 | | |
| 13b | | | | | | | 240 | 360 |
| 13c | 164 ± 57 | 214 | | | | | | |
| 14 | | | 58 | 34 | 29 | 23 | | |
| 15 | | | 43 | 36 | 37 | 30 | | |
| 16 | | | 77 | 70 | 56 | 39 | | |

As shown in Table 5, geopolymer compositions of the present invention provide the best balance of properties.

Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

1. A composition comprising:
(1) a reactive geopolymer mixture comprising
(A) a reactive solid comprising an aluminosilicate and a calcium source,
(B) an alkali activator,
(C) a solvent comprising or consisting of water, and
(2) a plasticizer additive comprising a water-soluble polymer component which is a homopolymer or copolymer containing repeat units derived from methacrylic acid or salts thereof, methacrylate, or mixtures thereof.

2. The composition of claim 1, wherein the aluminosilicate is selected from the group consisting of metakaolin, calcined clay, fly ash, incineration ash (including but not limited to rice husk, sugarcane leaves ash, palm oil, boiler ash, wastepaper sludge ash, municipal solid waste ash, bottom ash), natural pozzolans, volcanic ash, ground granulated blast furnace slag (from steel or iron), other industrial ground slag (including but not limited to phosphorous, ferronickel, ferrochrome magnesia-iron, copper, nickel, titaniferous), mine tailings or wastes (including but not limited to coal gangue, red mud), zeolite, feldspars, framework aluminosilicates, synthetic glassy precursors (silicates, aluminates, aluminosilicates) and mixtures thereof.

3. The composition of claim 1, wherein the aluminosilicate comprises or consists of metakaolin.

4. The composition of claim 1, wherein the aluminosilicate comprises at least 10% or at least 50% metakaolin.

5. The composition of claim 1, wherein the aluminosilicate comprises or consists of blast furnace slag.

6. The composition of claim 1, wherein the calcium source comprises a source of calcium oxide.

7. The composition of claim 1, wherein the calcium source comprises or consists of blast furnace slag.

8. The composition of claim 1, wherein the calcium source comprises or consists of hydrated lime.

9. The composition of claim 1, wherein the aluminosilicate is metakaolin and the calcium source is blast furnace slag.

10. The composition of claim 1, wherein the alkali activator component comprises or consists of an alkali silicate.

11. The composition of claim 1, wherein the alkali activator component contains or is derived from colloidal silica.

12. The composition of claim 11, wherein the alkali activator component comprises the reaction product of (a) an alkali metal oxide, an alkali metal hydroxide, an alkali metal carbonate, an alkali metal bicarbonate, alkali metal silicate or mixtures thereof with (b) colloidal silica.

13. The composition of claim 1, wherein the water-soluble polymer component comprises or consists of a salt of a polymer consisting of repeat units derived from methacrylic acid wholly or partially neutralized by lithium, sodium, or potassium or mixtures thereof, wherein the salt optionally includes other divalent ions selected from magnesium or calcium.

14. The composition of claim 13, wherein the water-soluble polymer component consists of a salt of a polymer consisting of repeat units derived from methacrylic acid repeat neutralized by a mixture of sodium and potassium.

15. The composition of claim 1, wherein the water-soluble polymer component has a weight average molecular weight measured by aqueous GPC of from 1000 to 40,000.

16. The composition of claim 1, wherein the reactive geopolymer mixture has a H₂O/MₓO ratio (Total Moles of Free or Potentially Released Water in the Geopolymer Composition/(((Total Moles of Li, Na, and/or K)/2)+Total Moles of Ca) of less than 14.

17. The composition of claim 1, wherein the composition further comprises sand.

18. An article made from the composition of claim 1.

19. A method comprising:
plasticizing an aluminosilicate geopolymer precursor mixture by combining (1) a reactive solid mixture comprising an aluminosilicate and a calcium source, (2) an alkali activator, and (3) a solvent comprising or consisting of water, with a plasticizing additive, wherein the plasticizing additive comprises a water-soluble polymer component which is a homopolymer or copolymer containing repeat units derived from methacrylic acid or salts thereof, methacrylate, or mixtures thereof.

20. The method of claim 19, wherein the aluminosilicate is selected from the group consisting of metakaolin, calcined clay, fly ash, incineration ash (including but not limited to rice husk, sugarcane leaves ash, palm oil, boiler ash, wastepaper sludge ash, municipal solid waste ash, bottom ash), natural pozzolans, volcanic ash, ground granulated blast furnace slag (from steel or iron), other industrial ground slag (including but not limited to phosphorous, ferronickel, ferrochrome magnesia-iron, copper, nickel, titaniferous), mine tailings or wastes (including but not limited to coal gangue, red mud), zeolite, feldspars, framework aluminosilicates, synthetic glassy precursors (silicates, aluminates, aluminosilicates) and mixtures thereof.

21. The method of claim 19, wherein the aluminosilicate comprises or consists of metakaolin.

22. The method of claim 21, wherein the aluminosilicate comprises at least 10% or at least 50% metakaolin.

23. The method of claim 19, wherein the aluminosilicate comprises or consists of blast furnace slag.

24. The method of claim 19, wherein the calcium source comprises a source of calcium oxide.

25. The method of claim 19, wherein the calcium source comprises or consists of blast furnace slag.

26. The method of claim 19, wherein the calcium source comprises or consists of hydrated lime.

27. The method of claim 19, wherein the aluminosilicate is metakaolin and the calcium source is blast furnace slag.

28. The method of claim 19, wherein the alkali activator component comprises or consists of an alkali silicate.

29. The method of claim 19, wherein the alkali activator component containing or derived from colloidal silica.

30. The method of claim 29, wherein the alkali activator component comprises the reaction product of (a) an alkali metal oxide, an alkali metal hydroxide, an alkali metal carbonate, an alkali metal bicarbonate, alkali metal silicate or mixtures thereof with (b) colloidal silica.

31. The method of claim 19, wherein the water-soluble polymer component comprises or consists of a salt of a polymer consisting of repeat units derived from methacrylic acid wholly or partially neutralized by lithium, sodium, or potassium or mixtures thereof, wherein the salt optionally includes other divalent ions selected from magnesium or calcium.

32. The method of claim 31, wherein the water-soluble polymer component consists of a salt of a polymer consisting of repeat units derived from methacrylic acid repeat neutralized by a mixture of sodium and potassium.

33. The method of claim 19, wherein the water-soluble polymer component has a weight average molecular weight measured by aqueous GPC of from 1000 to 40,000.

34. The method of claim 19, wherein the geopolymer precursor mixture has a H₂O/M₂O ratio (Total Moles of Free or Potentially Released Water in the Geopolymer Composition/(((Total Moles of Li, Na, and/or K)/2)+Total Moles of Ca) of less than 14.

35. The method of claim 19, further comprising the step of adding sand to the geopolymer precursor mixture and plasticizer.

36-37. (canceled)
